(19) United States
(12) Patent Application Publication
(10) Pub. No.: US 2019/0024027 A1
(43) Pub. Date: Jan. 24, 2019

(54) Fomulations and Methods for Sanitizing

(71) Applicant: Lynn Dowdle, Dallas, TX (US)

(72) Inventor: Lynn Dowdle, Dallas, TX (US)

(21) Appl. No.: 15/654,053

(22) Filed: Jul. 19, 2017

(51) Int. Cl. C11D 17/04; C11D 3/20; C11D 1/66; C11D 3/36; B08B 1/00; B08B 3/08; A47L 17/00

(52) U.S. Cl. CPC C11D 17/049; C11D 3/2065; C11D 1/662; C11D 3/2079; A47L 17/00; C11D 3/2086; C11D 3/2017; B08B 1/006; B08B 3/08; C11D 3/36

(57) ABSTRACT

A sanitizing formulation for removing contaminated residue from metal, glass, porcelain, polymeric and textile surfaces includes a non-ionic surfactant; water soluble preservative; pH reducer, chelating agent; glycerin; water; and optionally an edible fragrance. Optionally, the exemplary formulation includes from about 2.7 to about 3.3 wt. % isopropyl alcohol, or about 3 wt. %. Optionally, the surfactant is selected from the group consisting of sodium benzoate and potassium sorbate. In another exemplary embodiment, convenient wipes are provided that are impregnated with the formulation.

### BACKGROUND

### Technical Field

The technology relates to the field of cleaning formulations, applicators for such formulations, and methods of using such formulations and applicators; more particularly, the technology relates to removal of contaminated residues from surfaces and sanitizing the surfaces.

### Description of the Related Art

Cosmetics commonly referred to in the US as “make-up,” have been in use at least since the time of the Pharaohs. In the late 20^{th} century, the use of make-up increased significantly with the rise of major manufacturers and marketers such as Revlon, L'Oreal, Estee Lauder, Elizabeth Arden, and many others. The term “cosmetics” covers a wide range of products that are perceived to enhance beauty. Often, cosmetics include compositions that may have, or that are asserted as having, health enhancement properties, for example, “sun screen” agents in facial creams, to minimize potentially harmful levels of ultra-violet solar radiation, and lotions that include anti-oxidants.

With regard to cosmetics applied to the lips, these are available in a range of products, colors and textures. Lipstick is well known, and is most commonly supplied in a cylindrical container that allows presentation of the “stick” as a colored, waxy solid that can be easily applied to the lips. Lipstick generally includes pigments that provide the desired color, a carrier of a mixture of oils and waxes, and emollients (moisturizers and skin conditioners). Lip-gloss is a sheer composition applied to the lips, most commonly as a liquid using an applicator referred to as a “doe foot applicator,” to impart a glossy sheen. Lip balm may include a composition to prevent drying out of the lips, and may include a moisturizing conditioner. Lip balm is often clear (not colored) but may be colored. Lip plumper, which may be solid, gel/cream or liquid, is formulated with compositions, such as niacin or retinol, or a harmless skin irritant (e.g., menthol, camphor, cayenne, cinnamon), that causes the lips to swell and become fuller (“plumper”). Lip plumpers may range from translucent to any color desired. Lip plumper may be formulated to be used by itself as a lip-gloss, or may be formulated for receiving an application of lipstick over the lip plumper.

While there has been a growing trend toward the use of “natural” ingredients and organic ingredients in cosmetics, there has also been a demand for cosmetics that are suited to an active lifestyle, and for a busy work day. As a result, there has been a growing market for a long wearing lipstick that does not require frequent application and does not come off the wearer's lips readily, so that fresh application, or “touch up,” might be required fewer times daily, sometimes only once or twice in an eight hour work day. In response to this need, the cosmetics manufacturers developed new lipstick formulations. The “traditional” lipstick, which generally has to be “freshened” several times a day, has a “soft waxy solid” carrier structure that results from the use of a wax, or a mixture of waxes, typically including carnauba wax (a high melting point wax for structural support), beeswax, ozokerite, and candelilla wax. The carrier formulation further includes oils and fats that are blended with the waxes to provide the texture and sheen of the lipstick. These oils and waxes include, for example, olive oil, mineral oil, cocoa butter, lanolin, and petrolatum. Some may contain pig fat and castor oil in addition, to improve the shiny appearance when applied.

The recent introduction of “long wearing” lipstick was made possible by changes in lipstick formulations to include compositions that reduce the tendency of traditional lipstick to gradually wear off the lips during normal daily activities of talking, drinking, eating, etc. These formulations adhere more stubbornly to the lips, and may also be expected to adhere more stubbornly to other surfaces, for example the surface of a drinking glass or cup. This lipstick residue often resists cleaning in ordinarily used cleaning methods, for example automatic dish washing machines used in restaurants, resulting in the embarrassing presentation of a “cleaned” glass or cup with lipstick residue to a customer.

US Patent Publication 2005/0227884 discusses a method of removing lipstick residue, particularly such residue from long wearing lipstick, from a glass or cup (collectively, “drink ware”) by pretreating the used drink ware with a chemical formulation prior to the usual cleaning in a dish washing machine. The pretreatment formulation includes at least 0.1 to 100 wt. % of a solvent specified as a ketone; an ester, such as the soy esters; a paraffin hydrocarbon, such as Norpar 13, available from Exxon Mobil; and a glycol ether, glycol, or a terpene. In addition, the formulation includes an organic surfactant (from a specified list), a hydrotrope to assist in dissolving all the components of the formulation, a dye a viscosity modifier, and a source of alkalinity, such as sodium or potassium hydroxide, and a builder, such as sodium tripolyphosphate. The pretreating formulation is a liquid solution and may be applied either only to the rim of the drink ware, where the residue is typically found, or to the entire drink ware surface. The pretreatment solution can be applied by spraying, misting, foaming, dipping, wiping, fogging, or rolling. Thereafter, the drink ware is washed in a washing machine. There is no indication that the pretreatment solution is non-toxic, or that it can be ingested in any amounts, without harm. Since the drink ware is subsequently cleaned in a washing machine, toxicity may not be of concern.

U.S. Pat. No. 5,346,640 relates to a cleaning composition, asserted to clean graffiti from walls, and also lipstick from surfaces. The patent describes five different cleaning liquid compositions, each directed to a specific cleaning job. Each of the cleaning liquids includes the “stem ingredients” which are N-methylpyrrolidone, propylene carbonate, isocetyly alcohol, dipropylene glycol methyl (or mono-methyl) ether acetate.

PCT Publication WO 1998/004660 is directed to a glass washing composition said to be effective in cleaning lipstick from glass. The composition includes a nonionic surfactant, a suitable solvent, such as water, and optionally a co-solvent, such as a short chain alcohol. The nonionic surfactant may be present in the range 2.5 to 50 wt. %, and is preferably a low foaming surfactant selected from the alkoxylate surfactants. The co-solvent is preferably selected from isopropyl alcohol, white mineral spirits, glycols and sodium cumene sulfonate.

U.S. Pat. No. 4,600,522 relates to a biodegradable cleaning composition asserted to be effective in cleaning lipstick residues. This cleaning composition includes a furan-based alcohol mixed with a nonionic surfactant, an aromatizing composition, and an emulsifier.

U.S. Pat. Nos. 6,812,202 and 6,436,893 relate to an alkaline detergent composition asserted to be effective in cleaning lipstick residues. The detergent composition includes a blend of nonionic surfactants, an alkyl polyglycoside surfactant, and a silicon surfactant having a hydrophobic group and a pendant hydrophilic group.

A study in Spain showed that the tops of soda cans are more contaminated and full of germs and bacteria. So to wash them with water is advised before putting it to the mouth to avoid any kind of fatal accident. Beverage containers frequently have provision for opening a portion of the top of the can so that the purchaser can drink the contents directly from the can. The area that is to serve as the discharge opening is formed as a “knock-out” in the metal top, and a ring is secured to the knock-out near the center portion of the can top for tearing the knock-out from the can top so as to provide the discharge opening. Such containers have the disadvantage that the top of the can becomes dirty as the result of dust settling on it or other contaminants falling on it while it is standing on store shelves or elsewhere. Additionally, rodents and other pests can spread waste products onto the surfaces of the containers. Moreover, insecticides can be sprayed on areas where the cans are stored, and this insecticide accumulates and dries on top of the can. People who buy these containers often open them for immediate consumption and without either the facilities or the inclination to wash the container before bringing their lips in contact with the contaminated surfaces. Health authorities in some jurisdictions require that such self-opening containers have a plastic cover over the area around the discharge opening for protection from contamination. Such plastic covering adds considerable expense to preparation of the containers for sale; and the equipment for applying such plastic covers is a large expense to plants where beverage containers are labelled and packed. Furthermore, such plastic covers are not adequate for preventing contamination, because customers have favorite flavors and they break open several packs on the supermarket shelf and collect different favorite individual flavors which they purchase at the check-out counter. Store managers cannot effectively prevent this practice and the unsold containers remain on the store shelf with some or all of the containers deprived of their protection against dust, dirt and other contamination. Some of the containers that are purchased are stored on pantry shelves and elsewhere where they gather dust and dirt with no protection whatever for the areas around the discharge opening. Sometimes rats in the storage shelves may contaminate with urine that contains toxic and deadly substances.

### SUMMARY

Exemplary embodiments of the technology provide formulations, applicators or carriers for the formulations, and methods of using the formulations to remove cosmetic residue from surfaces, especially for removing more stubborn residues, such as, for example, long wearing lipstick residue from drink ware, clothing, and other surfaces. In the case of clear or translucent surfaces, the formulations provide a cleaned surface that is streak-free and shiny-clean to the eye.

In an exemplary embodiment, a non-toxic, sanitizing formulation for removing contaminated residue from the tops of beverage cans, coffee mugs and wine glass surfaces includes a non-ionic surfactant; water soluble preservative; pH reducer, chelating agent; glycerin; water; and optionally an edible fragrance. Optionally, the exemplary formulation may include from about 2.7 to about 3.3 wt. % isopropyl alcohol, or about 3 wt. %. Further optionally, the surfactant may be present at from about 0.5 to about 1 wt. %, or about 0.75 wt. %. Further optionally, the surfactant may be Caprylyl or Decyl Glucoside. Optionally, the formulation may have from about 0.2 to 0.3 wt. %, or about 0.25 wt. % of water soluble preservative. Further optionally, the water soluble preservative may be sodium benzoate or potassium sorbate or a combination thereof. Optionally, the formulation may have from about 0.1 to about 0.5 wt. %, or about 0.25 wt. % of chelating agent. Further optionally, the chelating agent is Phytic acid. Optionally, the formulation may have less than 0.01 wt. % of a pH reducer. Further optionally, the pH reducer is Citric acid. Optionally, the formulation may have less than 0.01 wt. % of glycerin.

Another exemplary embodiment provides a wipe impregnated with a non-toxic, sanitizing aqueous formulation for removing long wearing lipstick residue from glass, porcelain and plastic surfaces. Yet another exemplary embodiment provides a wipe impregnated with a non-toxic, sanitizing aqueous formulation for removing contaminated residue from the tops of beverage cans, coffee mugs and wine glass surfaces. The wipe acts as a carrier for a formulation and has about 2.7 to about 3.3 wt. % isopropyl alcohol, or 0.2 to 0.3 wt. %, or about 0.25 wt. % of water soluble preservative; an non-ionic surfactant; chelating agent; water soluble preservative; pH reducer and optionally an edible fragrance; and water. The wipe may optionally be made of woven fibers, such as nylon, cotton, and the like. Moreover, the wipe may be textured to provide a mild soft scrubbing to a surface and/or may be textured to enhance polishing of surfaces. The wipes can be individual wipes, individually packaged in a water tight, tearable enclosure, or can be a roll of connected, but perforated wipes in a tube for dispensing through.

In some exemplary embodiments the formulation is an aqueous liquid, and in other exemplary embodiments, it is an alcohol-based solution, free of water, which is added in the cleaning stage. In some embodiments it is supplied in a sealed sachet that dissolves in water to release the sanitizing and cosmetic residue-cleaning formulation contained therein. In other exemplary embodiments, it is provided as a concentrated bulk liquid for dispersal or mixing into water that will be used to clean cosmetic residue-marked surfaces and to sanitize these.

The foregoing summary is not exhaustive; more details and exemplary embodiments about the cosmetic residue removal formulation technology that is the subject of the appended claims are provided here below.

### BRIEF DESCRIPTION OF THE DRAWINGS

The following drawings are not to scale and depict exemplary, non-limiting embodiments that are intended to facilitate an understanding of the inventions, which are set forth in the appended claims. The technology may be best understood by reference to the following Detailed Description, when read in conjunction with the accompanying illustrative, not-to-scale drawing, wherein:

FIG. 1 depicts stem ware having a cosmetic residue on a rim surface.

FIG. 2A depicts an exemplary embodiment of a dispenser containing wipes impregnated with a formulation according to an embodiment of the invention.

FIG. 2B depicts an alternative embodiment of a dispenser containing wipes impregnated with a formulation according to an embodiment of the invention.

FIG. 2C depicts a further alternative embodiment of a dispenser containing a single wipe (or two or more wipes) impregnated with a formulation according to an embodiment of the invention

FIG. 3 depicts an exemplary embodiment of a single sheet wipe from a dispenser of FIG. 2.

FIG. 4 depicts an exemplary embodiment of a sachet containing a formulation according to an embodiment of the invention, for dispersal in either a dish washing machine or a laundry washing machine.

FIG. 5 depicts an exemplary embodiment of a device for cleaning the rim regions of stem ware by dunking in a formulation in accordance with exemplary embodiment of the invention.

FIG. 6 depicts examples of the use of exemplary embodiments of the formulation to clean clothing marked with cosmetic residue.

FIG. 7A depicts examples of the use of exemplary embodiments of the formulation to clean contaminated residue on top of a beverage can.

FIG. 7B depicts examples of the use of exemplary embodiments of the formulation impregnated into a wipe and packaged with a beverage can used to clean residue contaminated on top of a beverage can.

FIG. 7C depicts examples of the use of exemplary embodiments of the formulation impregnated into a wipe and packaged with a beverage can at the bottom and used to clean residue contaminated on top of a beverage can.

FIG. 8 depicts examples of the use of exemplary embodiments of the formulation to clean contaminated residue on a wine glass.

FIG. 9 depicts examples of the use of exemplary embodiments of the formulation to clean contaminated residue on a coffee mug.

FIG. 10A depicts an exemplary embodiment of a single sheet wipe of FIG. 2 comprising a scrubbable portion and a clean portion.

FIG. 10B depicts an exemplary embodiment of a single sheet wipe of FIG. 2 with a single texture.

FIG. 10C depicts an exemplary embodiment of a single sheet wipe of FIG. 2 comprising a first texture on first side and a second texture on a second side.

FIG. 11A depicts examples of the use of exemplary embodiments of the formulation to clean contaminated residue on top of a mobile device.

FIG. 11B depicts examples of the use of exemplary embodiments of the formulation impregnated into a wipe and packaged with a mobile device used to clean residue contaminated on the mobile device.

### DETAILED DESCRIPTION

The term “exemplary” as used herein, means “an example of,” and the examples provided herein are non-limiting of the invention, which is solely expressed in the patent claims.

In the specification and claims, the term “cosmetic residue” means residue that results from cosmetics having contacted a surface and having adhered to that surface after such contact. Sometimes at least a portion of that residue remains tightly bound to the surface, even after a standard cleaning procedure, appropriate to that surface, has been applied. While much of the following discussion focuses on lipstick, and long wearing lipstick, other cosmetics may have similar effects with regard to residues. Further, while much of the discussion may focus on drink ware, for ease of explanation, the formulations are also useful in cleaning other surfaces, such as clothing of natural or synthetic materials, or both, utensils, plates, pacifiers and anything that needs a sanitary finish.

In the specification and claims, the term “contaminated residue” means residue that results from dust, dirt, insecticides and/or any other particles including feces and urine that might collect on a surface and/or adhere to that surface after such collection.

The term non-toxic, as used in the specification and claims means compositions, and formulations of these compositions, that are either not toxic when ingested or that are present in such minute and barely detectible residual amounts, if any, on cleaned surfaces as to pose virtually no risk to human health, if ingested in food or drink in contact with that surface.

The term “sanitizing” as used in the specification and claims relates to the capability of embodiments of the formulation to clean surfaces having a cosmetic or contaminated residue of micro-organisms associated with that residue, to thereby significantly reduce the population of the micro-organism and any associated risk.

The introduction of long wearing lipstick has exacerbated an issue that has long presented in the field of cleaning glass and porcelain surfaces, in particular, of lipstick residue resulting from contact with lips of the wearer. Even after washing drink ware, for example, in a dish washing machine, at temperatures selected to ensure sterilization of pathogens, the residue often remains. Although the drink ware is not contaminated with pathogens, the residue is nonetheless unsightly and evokes feelings of distaste, resulting in a diminished impression of the standards of hygiene of an establishment that serves beverages in such drink ware. The removal of such residues is, therefore, of some significance to business establishments.

In addition, sometimes when make-up is being applied, the lipstick might slip from the grasp and in falling cause a mark on clothing: a blouse, scarf, skirt, pants, or the like. These marks are not readily removable with standard cleaning techniques, especially marks from long wearing lipstick. In fact, some techniques may result in “setting” of the mark and make it virtually impossible to remove this cosmetic residue later. Depending upon the prominence of the cosmetic residue, this potentially permanent “stain” may result in the clothing item being perceived as “ruined” and not fit for further use.

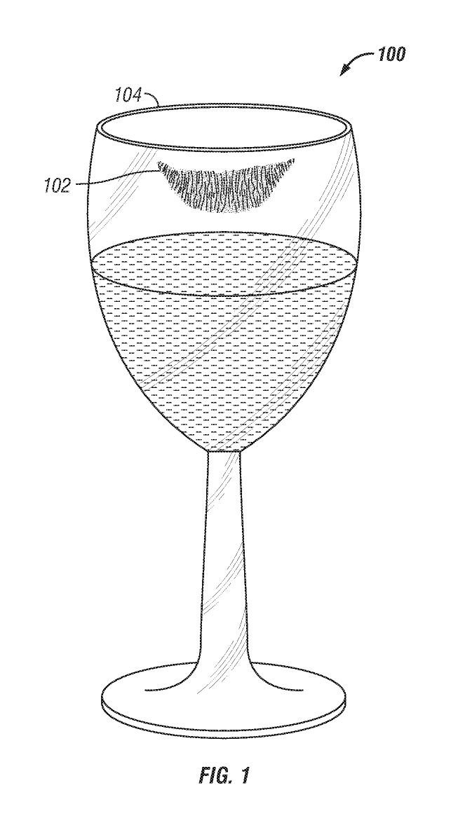

The recently introduced long wearing lipsticks pose more significant residue issues than the older “traditional lipsticks.” For example, referring to FIG. 1, even after putting drink ware, exemplified by wine glass 100, through a dish washing machine, stubborn residue 102 remains on the surface in the rim region 104 of the glass 100. The residue 102 may be more stubbornly attached in some cases and may be “baked on” after being subjected to high temperature washing with detergent, and hot air of drying of the washing machine. The same applies to long wearing lipstick marks on clothing that are “set” after heat drying during laundering. Whereas the traditional (not long wearing) lipstick formulations included waxes and oils, the long wearing lipsticks include wax-like synthetic polymers (also referred to herein as “polymeric waxes”) and dimethicones. These polymeric waxes and dimethicones provide the long wear characteristic, but also contribute markedly to producing the stubborn cosmetic residue.

An exemplary embodiment provides a sanitizing formulation for removing cosmetic residue from surfaces, especially glass, porcelain, and polymeric surfaces and the surfaces of clothing made from natural or synthetic fibers, or a combination of both. It is theorized, without being bound, that the efficacy of the exemplary formulation may arise from its component compositions. These compositions include a polar solubilizer for the polymeric waxes and dimethicones present in the long wear lipsticks. The solubilized polymeric waxes may interact with a surfactant, and are thereby rendered soluble in either the water of the formulation, if in aqueous form, or water added in the cleaning process. Because of detergent activity, the polymer waxes and dimethicones do not re-deposit. In addition, the formulations may include an anti-streaking agent that finish-cleans the surface to remove any streaks visible to the naked eye, and a conditioning agent that imparts a shiny, clean appearance.

In an exemplary embodiment, the surfactant is a non-ionic surfactant, or a mixture of such surfactants. In another exemplary embodiment, the surfactant is an ionic surfactant, or a mixture of such surfactants. Of these surfactants, a non-limiting, useful surfactant, or mixture of surfactants, may be selected from Caprylyl or Decyl Glucoside. Non-ionic surfactants that are non-toxic at levels of concentration left on cleaned surfaces, and with low or no risk of allergic reactions at these concentrations, are preferred. Furthermore, the surfactants may have some antimicrobial (preserving) ability. In addition, the surfactants may be mild, low in toxicity, readily biodegradable and do not leave any streaks on the surfaces that are cleaned.

In an exemplary embodiment, the anti-streaking agent that cleans clear or translucent surfaces to a visibly streak-free appearance may be isopropyl alcohol, for example, or a like anti-streaking agent. Anti-streaking agents that are non-toxic at levels of concentration left on cleaned surfaces, and with low or no risk of allergic reaction are preferred. A combination of the isopropyl alcohol along with the surfactants cleans surfaces to a visibly streak-free appearance while providing anti-microbial properties.

The anti-streaking agent is not essential, for example on porcelain that is opaque, but provides an added assurance of a streak free shine to clear or translucent surfaces, for example, acrylic or glass stem ware.

In an exemplary embodiment, the combination of a water soluble preservative, a chelating agent, and pH adjuster in the formulation may prevent the product and/or the formulation from microbial contamination. Isopropyl alcohol content by itself may not be sufficient enough to preserve the product. A chelating agent may sequester metals from the water or the aqueous formulation. In an exemplary embodiment, a non-limiting example the chelating agent may be phytic acid. According to another exemplary embodiment, the sanitizing formulation may further comprise a pH reducer such that the preservatives in the formulations are more effective. In an exemplary embodiment, a non-limiting example pH reducer may be citric acid.

In an exemplary embodiment, a non-limiting example of the conditioning agent may be glycerin. Glycerin is non-toxic and provides a shiny, cleanly polished look to smooth surfaces, such as glass, acrylic or porcelain, for example. Conditioning agents that are non-toxic at levels of concentration left on cleaned surfaces, and with low or no risk of allergic reactions at these concentrations, are preferred.

In an exemplary embodiment, a non-toxic, sanitizing formulation for removing contaminated residue from the tops of beverage cans, coffee mugs and wine glass surfaces includes a surfactant; water soluble preservative; pH reducer, chelating agent; glycerin; water; and optionally an edible fragrance. Optionally, the exemplary formulation may include from about 2.7 to about 3.3 wt. % isopropyl alcohol, or about 3 wt. %. Further optionally, the surfactant may be present at from about 0.5 to about 1 wt. %, or about 0.75 wt. %. Further optionally, the surfactant may be Caprylyl or Decyl Glucoside. Optionally, the formulation may have from about 0.2 to 0.3 wt. %, or about 0.25 wt. % of water soluble preservative. Further optionally, the water soluble preservative may be sodium benzoate or potassium sorbate or a combination thereof. Optionally, the formulation may have from about 0.1 to about 0.5 wt. %, or about 0.25 wt. % of chelating agent. Further optionally, the chelating agent is Phytic acid. Optionally, the formulation may have less than 0.01 wt. % of a pH reducer. Further optionally, the pH reducer is Citric acid. Optionally, the formulation may have less than 0.01 wt. % of glycerin. The remainder of the composition is water, preferably deionized, to avoid ionic interference with the surfactant activity.

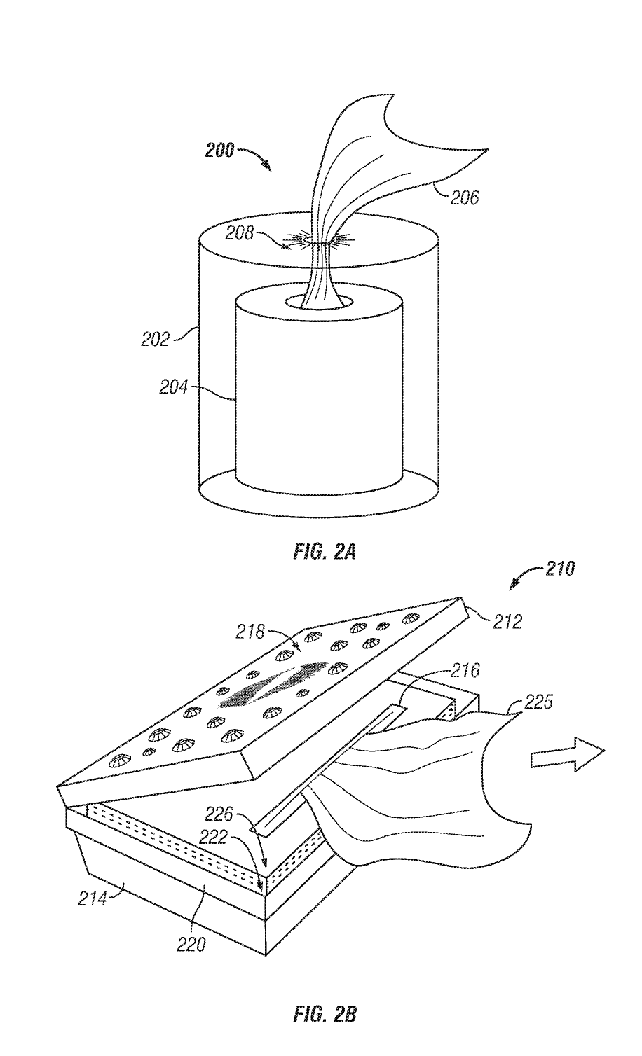

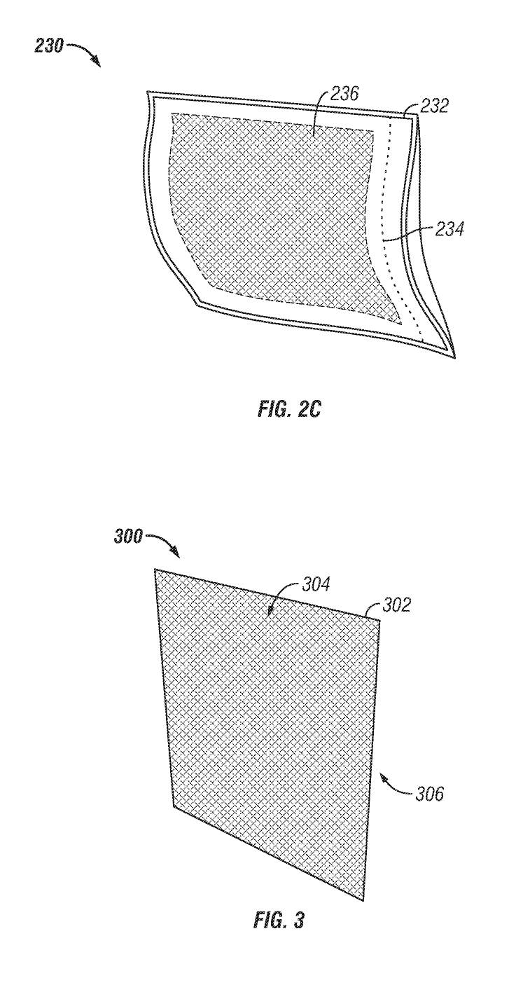

FIG. 2A depicts an exemplary embodiment of a wipe dispenser 200, including a container 202 with a roll of wipes 204 therein. The wipes 206 may be pulled through the top 208 of container 202, which has means to detach one wipe 206 at a time as it exits from the container 202. An exemplary embodiment of a wipe 300, depicted in FIG. 3 has a first side 302 that includes texture 304 providing a roughened surface for scrubbing. The texture may be created by fibers, or by other suitable inclusions within the wipe material. The other side 302 of the wipe is not visible, but may be roughened or may be free of such surface roughening features, and may be suitable for polishing.

FIG. 2B shows an alternative embodiment in which a plurality of wipes 226 are enclosed within a hinged case 210 that is sized to facilitate carrying in a women's purse or bag. In a non-limiting example, the case 210 may be about 2.5 inches wide, by about 4.5 inches long, and about 0.5 inches thick, and may have an attractive design (or coloration) on at least the upper surface 218 of lid 212. The lid 212 of case 210 is hinged to the base 214 that has an internal cavity for receiving multiple suitable folded wipes 226. The upper surface of the base 220 includes a slot 216 through which individual wipes 225 may be pulled from the case, one after the other. To facilitate refilling the case 210 when all wipes have been removed and used, the base 214 may have a hinged or otherwise removable upper lid 220 that allows access to the cavity inside base 214 for placing replacement wipes 226 therein. In an exemplary embodiment the case may be made from a suitable light-weight plastic material that is substantially non-reactive with the formulation on the wipes. In order to minimize evaporation of formulation from the wipes 226, the lid 212 may be designed to fit snugly over the upper edge of base 214 and seals to the base along the contact perimeter with the base 214. Other containment techniques to minimize evaporation may also be used.

FIG. 2C depicts a handy, easy-to-carry sealed-pouch embodiment 230 of the technology. The pouch 232 contains a single wipe, or a pair of wipes 236 impregnated with an embodiment of a non-toxic, sanitizing formulation that is sealed within a pouch 232 of a material that minimizes or prevents evaporation of the formulation from the wipe(s). Such a material may be selected from non-reactive plastic films, metalized plastic films, or metal films. The pouch 232 optionally has a score-line that provides a line of weakness to facilitate tearing the pouch open to access the wipe(s) inside.

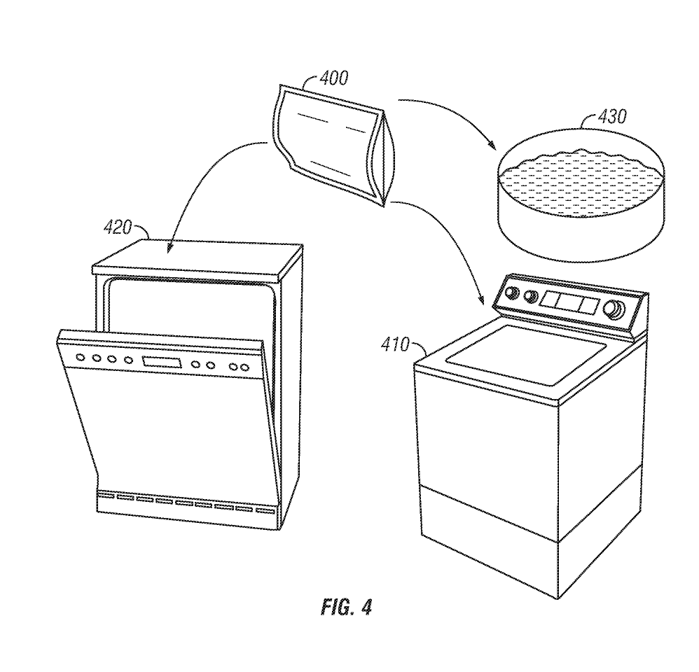

Another exemplary embodiment provides a sachet filled with a non-toxic formulation for removing long wearing lipstick residue from glass, porcelain and plastic surfaces. In an exemplary embodiment, the sachet is sealed, but is water soluble, in exemplary embodiments. The sachet maintains the formulation within it until the shell of the sachet dissolves in the water that is used to clean the affected surfaces. As depicted in FIG. 4, the sachet 400 may be deposited into a clothes washing machine 410, or a dish washing machine 420, or to a tub 430 for manual washing of clothes or drink ware, or any other washable articles that have a cosmetic residue. The formulation a non-ionic surfactant; water soluble preservative; pH reducer, chelating agent; glycerin; water; and optionally an edible fragrance. Optionally, the exemplary formulation may include from about 2.7 to about 3.3 wt. % isopropyl alcohol, or about 3 wt. %. Further optionally, the surfactant may be present at from about 0.5 to about 1 wt. %, or about 0.75 wt. %. Further optionally, the surfactant may be Caprylyl or Decyl Glucoside. Optionally, the formulation may have from about 0.2 to 0.3 wt. %, or about 0.25 wt. % of water soluble preservative. Further optionally, the water soluble preservative may be sodium benzoate or potassium sorbate or a combination thereof. Optionally, the formulation may have from about 0.1 to about 0.5 wt. %, or about 0.25 wt. % of chelating agent. Further optionally, the chelating agent is Phytic acid. Optionally, the formulation may have less than 0.01 wt. % of a pH reducer. Further optionally, the pH reducer is citric acid.

Another exemplary embodiment provides a bulk liquid non-toxic formulation for removing long wearing lipstick residue from glass, porcelain and plastic surfaces. The formulation is in concentrated form and can be diluted with water, preferably deionized water, in a 50:50 ratio. The bulk formulation prior to dilution may include from about 2.7 to about 3.3 wt. % isopropyl alcohol, or about 3 wt. %. Further optionally, the surfactant may be present at from about 0.5 to about 1 wt. %, or about 0.75 wt. %. Further optionally, the surfactant may be Caprylyl or Decyl Glucoside. Optionally, the formulation may have from about 0.2 to 0.3 wt. %, or about 0.25 wt. % of water soluble preservative. Further optionally, the water soluble preservative may be sodium benzoate or potassium sorbate or a combination thereof. Optionally, the formulation may have from about 0.1 to about 0.5 wt. %, or about 0.25 wt. % of chelating agent. Further optionally, the chelating agent is Phytic acid. Optionally, the formulation may have less than 0.01 wt. % of a pH reducer. Further optionally, the pH reducer is citric acid.

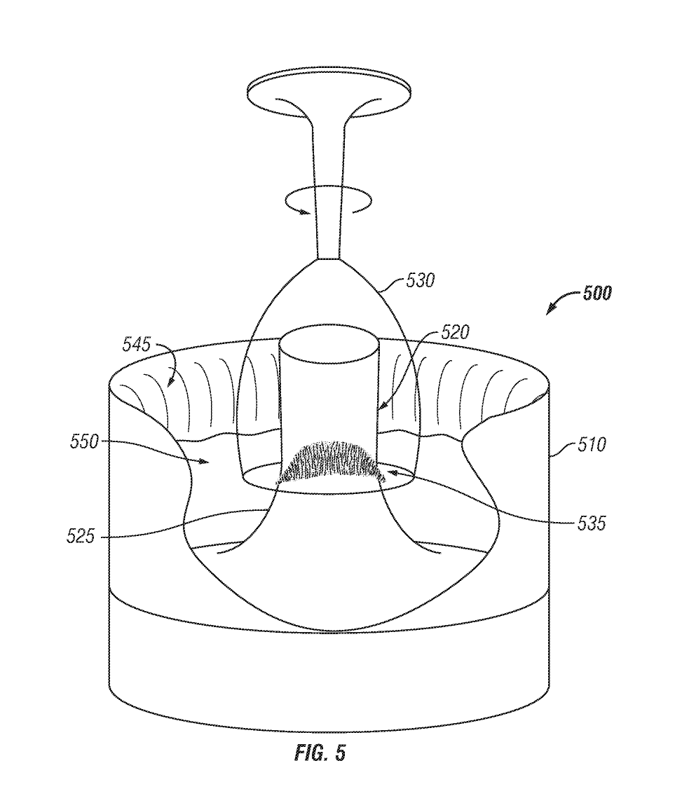

Referring to FIG. 5, the bulk liquid may be dispensed in measured amounts into an exemplary embodiment of a drink ware washing apparatus 500. The apparatus 500 includes a substantially cylindrically shaped tub 510 that is at least partially filled with a formulation according to an exemplary embodiment. The tub 510 has a central vertical guide 520 adapted to receive the opening of a glass 530 or cup. By guiding the rotation of the glass 530 appropriately, its rim 535 that has cosmetic residue rubs against the inner side surface 545 of the tub 510 as well as against the outer surface 525 of the guide 520. These surfaces 545 and 525 may be slightly roughened but yielding to facilitate scrubbing of the cosmetic residue 535 from the glass 530 with the formulation 550 that at least partially fills tub 510. Or tub 510 may be lined with wipes, as described above, to facilitate the rapid cleaning of large numbers of glasses in a short time.

An exemplary embodiment of the formulation for removing cosmetic residues from surfaces includes chemical components that are non-toxic and have low risk of producing an allergic reaction when a human is exposed to the minor amounts left behind on a surface after that surface has been cleaned using the formulation, whether such exposure is by touch or through ingestion as from cleaned drink ware.

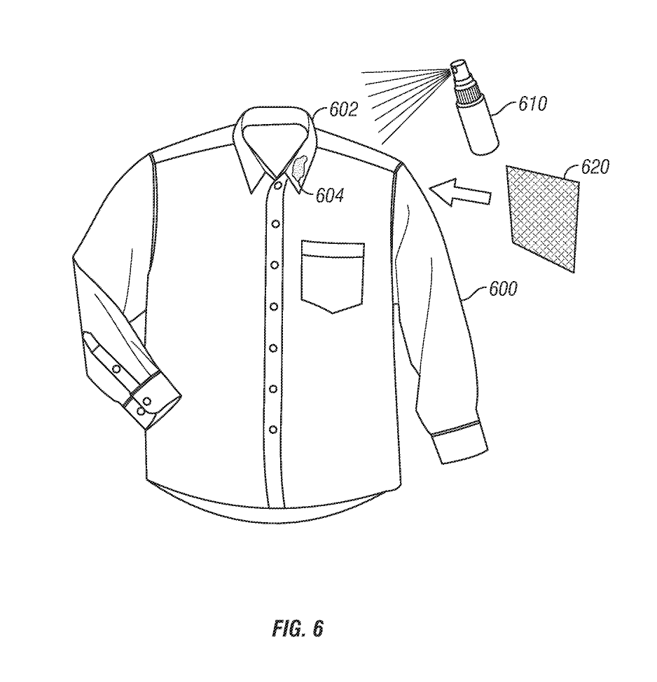

FIG. 6, depicts cosmetic residue 604 on a textile fabric, in this example, a collar 602 of a shirt or blouse 600. An exemplary embodiment of the non-toxic formulation of the technology may be supplied in a spray bottle 610. This permits spraying a directed spray or stream of the formulation directly onto the contaminated area of the clothing to facilitate removal of the cosmetic residue 604. This removal may require additional actions, such as blotting with an absorbent cloth or sponge and repeated application of the spray-on formulation. Alternatively, a wipe 620, like that described above, with reference to FIG. 3, for example, impregnated with an embodiment of a formulation in accordance with the invention, may be used to selectively blot formulation onto the area affected by the cosmetic residue 604 and to thereby remove it. During blotting, care should be taken to avoid spreading the cosmetic residue to other parts of the garment or fabric.

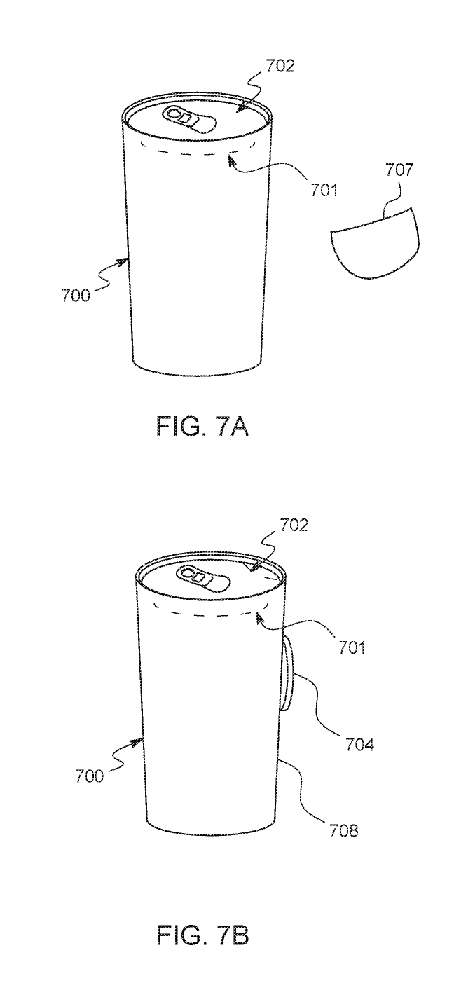

FIG. 7A, depicts a beverage can 700 with contaminated residue 701 collected on the can. Such beverage cans have the disadvantage that the top 702 of the can becomes dirty as the result of dust settling on it or other contaminants including feces and urine falling on it while it is standing on store shelves or elsewhere. Sometimes insecticides are sprayed on areas where the cans are stored, and this insecticide accumulates and dries on top of the can. People who buy these beverage cans often open them for immediate consumption and without either the facilities or the inclination to wash the beverage cans before bringing their lips in contact with the contaminated surfaces. An exemplary wipe impregnated with a formulation to clean the contaminated residue from the beverage can may comprise the following composition as illustrated in Table 1.0.

TABLE 1.0

| INGREDIENTS | % w/w |
|---|---|
| Water | 93.00-98.00 |
| Isopropyl Alcohol | 2.70-3.30 |
| Caprylyl/Decyl Glucoside | 0.50-1.00 |
| Sodium Benzoate | 0.20-0.30 |
| Phytic Acid | 0.10-0.50 |
| Potassium Sorbate | 0.10-0.30 |
| Glycerin | <0.01 |
| Citric Acid | <0.01 |

Another exemplary wipe impregnated with a formulation to clean the contaminated residue from the beverage can may comprise the following composition as illustrated in Table 2.0.

TABLE 2.0

| INGREDIENTS | % w/w |
|---|---|
| Water | 75.00-98.6988 |
| Isopropyl Alcohol | 1-10 |
| Caprylyl/Decyl Glucoside | 0.1-2.00 |
| Sodium Benzoate | 0.10-0.50 |
| Phytic Acid | 0.001-1 |
| Potassium Sorbate | 0.10-0.50 |
| Glycerin | .0001-10 |
| Citric Acid | .0001-1 |

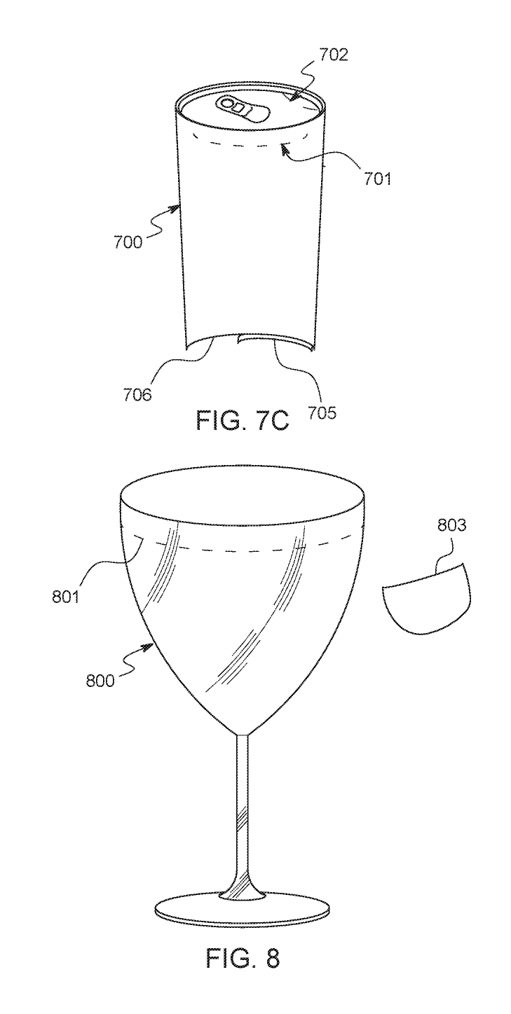

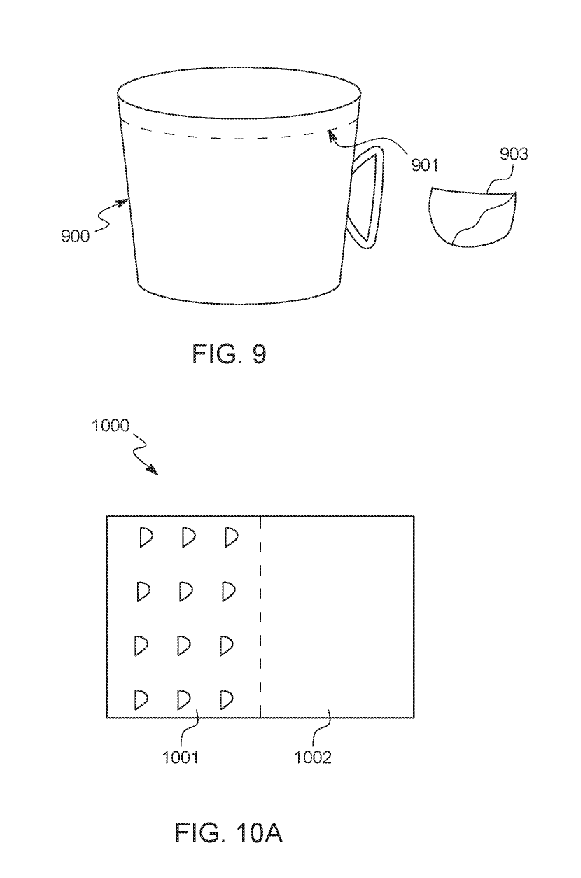

A further exemplary embodiment provides a sanitizing wipe impregnated with a non-toxic aqueous formulation for removing cosmetic residue such as long wearing lipstick residue from glass, porcelain and plastic surfaces. Yet another exemplary embodiment provides a sanitizing wipe impregnated with a non-toxic aqueous formulation for removing residue contaminated with dirt and dust from surfaces such as beverage cans, coffee mugs and the like. The wipe acts as a carrier for a formulation having a non-ionic surfactant; water soluble preservative; pH reducer, chelating agent; glycerin; water; and optionally an edible fragrance; and water. The wipe may optionally be made of woven fibers, such as nylon, cotton, paper-pulp fiber, and the like, and mixtures of such fibers. Moreover, the wipe may be textured to provide a mild soft scrubbing to a surface and/or may be textured to enhance polishing of surfaces. An exemplary embodiment includes a wipe that has a rougher texture on one side for facilitating a slight scrubbing action, and a smoother surface of the other side to facilitate a polishing action. Optionally, the exemplary formulation may include from about 2.7 to about 3.3 wt. % isopropyl alcohol, or about 3 wt. %. Further optionally, the surfactant may be present at from about 0.5 to about 1 wt. %, or about 0.75 wt. %. Further optionally, the surfactant may be Caprylyl or Decyl Glucoside. Optionally, the formulation may have from about 0.2 to 0.3 wt. %, or about 0.25 wt. % of water soluble preservative. Further optionally, the water soluble preservative may be sodium benzoate or potassium sorbate or a combination thereof. Optionally, the formulation may have from about 0.1 to about 0.5 wt. %, or about 0.25 wt. % of chelating agent. Further optionally, the chelating agent is Phytic acid. Optionally, the formulation may have less than 0.01 wt. % of a pH reducer. Further optionally, the pH reducer is Citric acid. Optionally, the formulation may have less than 0.01 wt. % of glycerin. The beverage can in one preferred exemplary embodiment may be packaged with the exemplary sanitary wipe impregnated with the formulation to enable a user to wipe the top surface of a beverage can providing a sterile surface free of micro-organisms associated with the residue on the contaminated surface. The user may open the can for immediate consumption before bringing their lips in contact with the top of the beverage can. The wipe may further be packaged with the beverage at a plurality of points through any adhesion means. For example, as illustrated in FIG. 7B, the wipe 704 could be packaged to the sides 708 of the can. In another example illustrated in FIG. 7C, the wipe may be attached to the bottom 706 of the beverage can 700 in the concealed portion which may be concave shaped. It must be noted that the wipe may be packaged at any attachment point of the beverage can and the locations of the attachment points may not be construed as a limitation. Additionally, according to another exemplary embodiment, the wipe may be disconnected and used separately to clean the surfaces of a beverage can providing a sterile surface free of micro-organisms associated with the residue on the contaminated surface. Similarly, as illustrated in FIG. 8, the exemplary wipe 803 cleans residue 801 collected on a wine glass 800. The sanitizing wipe may be impregnated with a non-toxic aqueous formulation for removing residue contamination on surfaces of wine glasses and beverage cans. The wipe acts as a carrier for a formulation having a non-ionic surfactant; water soluble preservative; pH reducer, chelating agent; glycerin; water; and optionally an edible fragrance; and water. Likewise, as illustrated in FIG. 9, the exemplary wipe 903 cleans residue 901 collected on a coffee mug 900. The sanitizing wipe may impregnated with a non-toxic aqueous formulation for removing residue contaminated with dirt and dust from surfaces of the wine glass. The wipe acts as a carrier for a formulation having a non-ionic surfactant; water soluble preservative; pH reducer, chelating agent; glycerin; water; and optionally an edible fragrance; and water. The sanitizing wipe may be used on several surfaces such as a deli table for making sandwiches and that needs a sterile surface. Another application is spouts of a bottles such as sport bottles that are consumed directly from the spout.

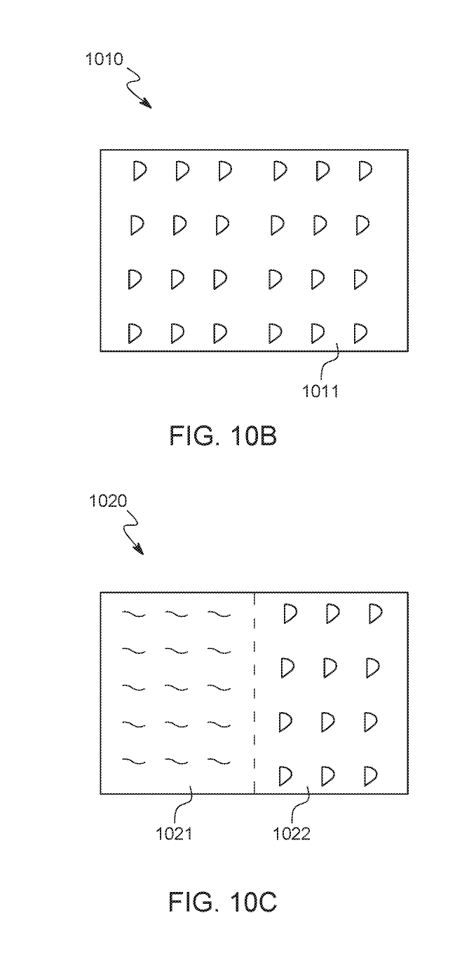

FIG. 10A depicts an exemplary embodiment of a single sheet wipe 1000 of FIG. 2 comprising a scrubbable portion 1001 and a clean portion 1002. The scrubbable portion may be impregnated with the exemplary formulation. A user may hold the clean portion 1002 while scrubbing or cleaning a residue on a surface with the scrubbale portion 1001 so that the user does not contact the formulation. The wipe 1000 may be divided into equal or unequal portions of the scubbable and clean portions. For example, the scrubbable portion 1001 may be 50% and the clean portion 1002 may be 50% of the area of the wipe. In another example, the scrubbable portion 1001 may be 70% and the clean portion 1002 may be 30%. The formulation in the wipe may be ingestible unlike commercially available sanitizing wipes.

FIG. 10B depicts an exemplary embodiment of a single sheet wipe (1010) of FIG. 2 with a single texture (1011). The texture may be customized to be smooth, rough or mild depending on the extent of sanitization or the extent of surface that needs to be sanitized.

FIG. 10C depicts an exemplary embodiment of a single sheet wipe (1020) of FIG. 2 comprising a first texture (1021) on a first side and a second texture (1022) on a second side. The first side and second side may be selected to be the two faces of the wipe. Alternatively, the first side and the second side may the diagonally separated.

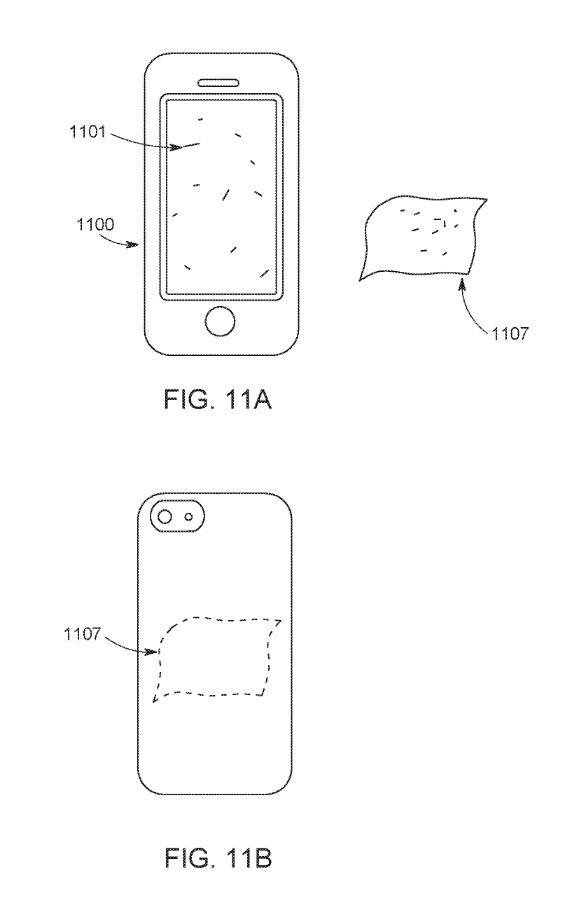

FIG. 11A depicts a mobile device (1100) with contaminated residue (1101) collected on the device. The devices may be carried along in a purse, pocket, car holder and the like and are therefore prone to contamination. The device may collect contamination when they are carried to places such as restrooms, crowded fields, restaurants, kitchens, malls, and so on. An exemplary wipe (1107) impregnated with a formulation to clean the contaminated residue from the mobile device may comprise the composition as illustrated in Table 1.0 or Table 2.0. FIG. 11B depicts an exemplary wipe attached to the back of a mobile device (1100) so that the device may be cleaned as necessary.

While exemplary embodiments have been particularly shown and described, it will be understood by those skilled in the art that various changes in form and detail may be made therein without departing from the spirit and scope of the patent claims, and such equivalents thereof that a court may provide under the doctrine of equivalents.

1. A method of removing residue from a contaminated surface, the method comprising steps of:
applying to the residue on the contaminated surface with a wipe impregnated with an aqueous formulation comprising concentrations of
a non-ionic surfactant;
isopropyl alcohol;
a water soluble preservative;
a chelating agent;
a pH reducer; and
glycerin;
wherein the concentrations of the isopropyl alcohol, the preservative, the chelating agent, the pH reducer and the glycerin are sufficient to remove the residue from the contaminated surface; and
providing a sterile surface free of micro-organisms associated with the residue on the contaminated surface.

2. The method of claim 1, wherein the isopropyl alcohol comprises from about 2.7 to about 3.3 wt. %.

3. The method of claim 1, wherein the formulation comprises water from about 93 to about 98 wt. %.

4. The method of claim 1, wherein the non-ionic surfactant is decyl glucoside.

5. The method of claim 1, wherein the non-ionic surfactant comprises from about 0.5 to about 1 wt. %.

6. The method of claim 1, wherein the preservative is sodium benzoate.

7. The method of claim 1, wherein the sodium benzoate comprises from about 0.2 to about 0.3 wt. %.

8. The method of claim 1, wherein the preservative is potassium sorbate.

9. The method of claim 1, wherein the potassium sorbate comprises from about 0.1 to about 0.3 wt. %.

10. The method of claim 1, wherein the chelating agent is phytic acid.

11. The method of claim 1, wherein the chelating agent comprises from about 0.1 to about 0.5 wt. %.

12. The method of claim 1, wherein the pH reducer is citric acid.

13. The method of claim 1, wherein the pH reducer comprises less than 0.01 wt. %.

14. The method of claim 1, wherein the glycerin comprises less than 0.01 wt. %.

15. The method of claim 1, wherein when the contaminated surface is glass, the sterile surface has a streak-free, shiny, polished appearance.

16. The method of claim 1, wherein the contaminated surface is an outside surface of a beverage can.

17. The method of claim 1, wherein the wipe comprises a scrubbing portion and a clean portion; the scrubbing portion impregnated with the formulation and the clean portion is formulation fee and configured for a human to hold for scrubbing the contaminated surface.

18. The method of claim 17, wherein the wipe comprises woven fibers.

19. The method of claim 1, wherein the step of applying comprises applying the formulation by spraying onto a textile fabric and blotting with an absorbent substrate to remove the residue from the contaminated surfaces.

20. The method of claim 1, further comprising, prior to wiping, removing the wipe from container having a plurality of wipes impregnated with the formulation therein.
